(19) United States
(12) Patent Application Publication
(10) Pub. No.: US 2002/0173414 A1
(43) Pub. Date: Nov. 21, 2002

(54) Method of and apparatus for sealing zipper to a substrate

(76) Inventor: Murray Edward Bruce Leighton, Yorkshire (GB)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/088,042

(22) PCT Filed: Jul. 5, 2001
(86) PCT No.: PCT/GB01/02968

(30) Foreign Application Priority Data
Jul. 15, 2000 (GB) 0017307.0

(51) Int. Cl. B31B 1/84

(52) U.S. Cl. 493/213

(57) ABSTRACT

A reclosable fastener (10) comprising a two-part body and a single flange (16) is located between two webs (34) of material from which a bag is to be made on a form-fill-seal machine. The fastener is attached initially to the inside of one web (34) by the flange (16). The combination passes between sealing jaws (44) to seal the webs to the fastener at thickened zones (30) at the margins of the body By making the body compact, and by using sealing jaws (44) which are longer than the body, the webs (34) form around the ends of the fastener body.

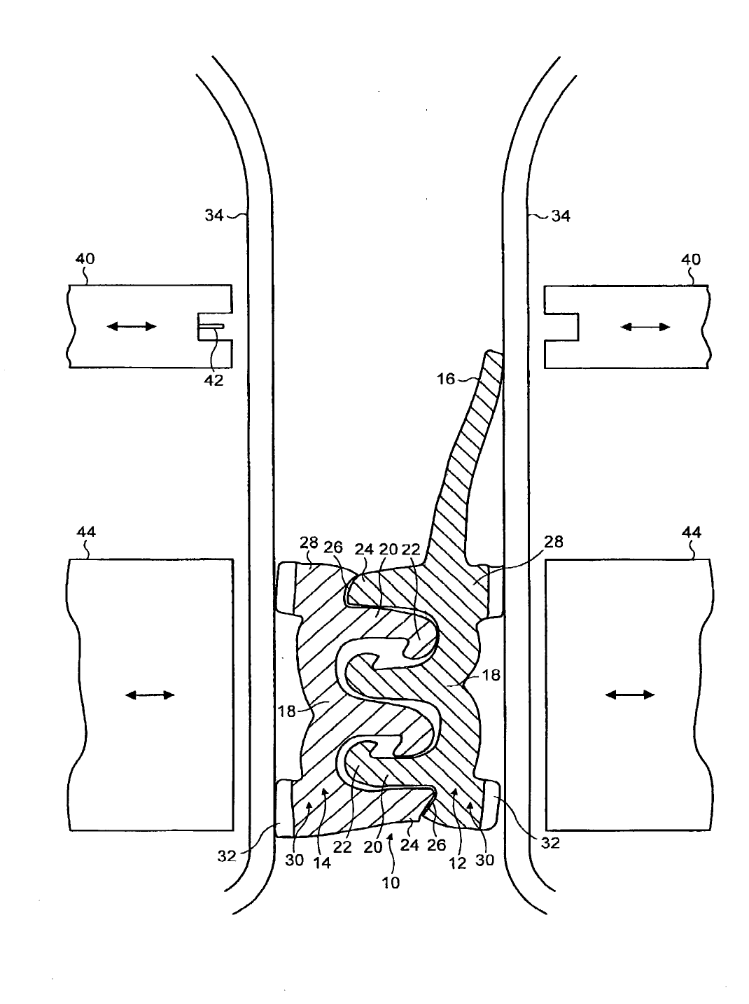

### FIELD OF THE INVENTION

This invention relates to methods of and apparatus for sealing reclosable fasteners, otherwise know as zippers, to a web or film, in the manufacture of plastics bags and other containers.

The invention is particularly concerned with the sealing of zippers on form/fill/seal machines, vertical or horizontal, and more especially where the zipper is applied to the substrate using cross-web techniques.

### BACKGROUND TO THE INVENTION

When a zipper strip is applied to a film or web, heat and pressure are applied to effect the welding of the zipper to the film or web. The heat and/or the pressure can result in damage to the closure. Various measures have been adopted to try to minimise the effects of the heat and pressure. For example, the welding can be of flanges extending laterally from the reclosable male and female elements, to try to minimise damage to the closure. However, it can still happen that the zipper is damaged or distorted as a result of these external influences.

Our UK patent application GB0016894.8 describes a novel zipper whose design is resistant to distortion or damage due to the welding heat and/or pressure.

In this application there is described a reclosable fastener for plastics bags and other containers, comprising two. elements, each element comprising at least one hook engageable with a hook of the other element, and each element comprising an upstanding post at the margin of the fastener which is engageable with a heel of the other element at the opposing margin of said other element, wherein the respective posts and heels of the two elements are angled at their respective contact surfaces.

The fact that the respective contact surfaces of the posts and heels are angled or mitred enables the closure more easily to resist pressure without distortion and without the hooks being squashed. The margins of the closure are more easily able to resist bending and to maintain their desired supporting function.

### SUMMARY OF THE INVENTION

In accordance with the present invention there are provided methods of and apparatus for sealing such a zipper to a substrate by the use of sealing jaws.

In accordance with the invention there is provided a method of sealing a reclosable fastener to a substrate which comprises presenting lengths of fastener to a continuous substrate, locating the lengths of fastener on the substrate by attaching them to the substrate so as to leave a body of the fastener free for movement, and passing the combination between a pair of sealing jaws which are dimensioned to be longer than the body of the fastener along the path of movement of the combination and which are displaceable relative to the combination to effect a sealing of the substrate to the fastener body when moved into contact therewith.

Preferably, the length dimension of the sealing jaws is such as to form the substrate around the body of the fastener.

A preferred embodiment of the method includes locating the fastener between two substantially parallel webs of material, and initially attaching the lengths of fastener only to the inside of one of said webs of material.

With the method of the present invention the sealing of the full zipper profile to the substrate is effected within the jaw area. This is in contrast to other known methods where zipper flanges only are sealed to the substrate in this area.

In a preferred embodiment, the body of the fastener comprises two engageable elements, each having an upstanding post at the margin of the fastener which is engageable with a heel of the other element at the opposing margin of said other element, with the respective posts and heels of the two elements being angled at their respective contact surfaces.

An advantage of this method is that because of the zipper design, with the mitred posts and heels, and the consequent resistance to distortion, a smaller zipper profile can be used and the bars of the sealing jaws can be relatively large. The relatively small height of the profile and the use of gripper bars means that the web or film forms around the zipper profile and does not cause heat marks on the web or film. This allows a greater degree of bag length variation in the host unit.

Also in accordance with the invention there is provided apparatus for sealing a reclosable fastener to a substrate, comprising means for presenting lengths of fastener to a continuous substrate, means for attaching the lengths of fastener initially to the substrate so as to leave a body of the fastener free for movement, and a pair of sealing jaws between which the combination is arranged to pass, said jaws being dimensioned to be longer than the body of the fastener along the path of movement of the combination and being displaceable relative to the combination to effect sealing of the substrate to the fastener body when moved into contact therewith.

### BRIEF DESCRIPTION OF THE DRAWING

In order that the invention may be more fully understood, one presently preferred embodiment of method and apparatus in accordance with the invention will now be described by way of example and with reference to the accompanying drawing which is a schematic cross-sectional view through the apparatus and zipper.

### DESCRIPTION OF THE PREFERRED EMBODIMENT

Referring to the drawing, there is shown a zipper, indicated generally at 10, comprising a first element 12 and a second element 14. The two elements 12 and 14 are generally the same as each other, apart from the fact that element 12 is provided with a single elongate flange 16. Each element 12, 14 comprises a body portion 18 with two upstanding legs 20 which terminate in hooks 22. The respective hooks 22 of the two elements 12 and 14 are interengageable to make the reclosable fastener.

Each element 12, 14 also comprises an upstanding support post 24 at one margin. The support post 24 is slightly longer than the hooked legs 20, 22 so that it extends slightly beyond the tops of the legs. The upper end surface 26 of each post 24 is tapered to provide an angled contact surface. Facing each support post 24, on the opposing element, there is provided a heel portion 28, again at the margin. The surface of each heel portion 28 facing the respective post 24 is shaped to be complementary to the angled contact surface 26. As can be seen from the drawing, with this arrangement, the respective posts and heels nest with one another to provide a shape-locking configuration which tends to resist squashing or outward bending under applied load. The angled contact surfaces are able to absorb the welding pressure and maintain their linear integrity, thus preventing the hooked legs 20, 22 from being squashed or distorted.

In order to reduce the effects of the welding heat, each of the closure elements 12 and 14 is provided with a pair of thickened areas 30 on the outside face remote from the legs 20. The respective thickened areas 30 are again provided at the margins of the closure, in alignment with the posts 24 and heel portions 28. The thickened areas 30 are provided by a thickening of the material of which each of the two elements is composed. Because of the additional bulk provided by the thickened areas 30, they also contribute to the resistance of the closure to deformation due to pressure. On each thickened area 30 there is provided a layer 32 of a material which is a high-performance sealing/welding material or blend of materials, such as EVA for example. This facilitates the welding of the zipper to an adjacent web or film 34. The layers 32 are co-extruded with the closure elements 12 and 14.

The single long flange 16 which is part of element 12 is arranged to face and be attached to the inside of the web or film 34 on one side of the bag. The zipper comprising a body and a single flange is located by a cross-web technique at the correct position between two continuous webs 34 of material.

In the method of manufacturing a plastics bag or other container on a form-fill-seal (FFS) machine, lengths of zipper 10 are presented to and located between two continuous webs or films 34 by a cross-web technique and initially are welded just by the single flange 16 to the inside surface of one web 34, leaving the body of the zipper free for movement. The partially formed bag carrying the zipper strip then passes through a first pair of reciprocating sealing jaws 40, one of which incorporates a knife blade 42 whose purpose is to sever the filled and sealed bags.

Following the jaws 40 is a second pair of sealing jaws 44, at least one of which, and preferably both, is displaceable towards and away from the path along which the partially formed bag travels. The jaws 44 are relatively large and the zipper 10 is relatively small and compact. The length dimension of the jaws 44 in the direction of movement of the zipper/substrate combination is longer than the body of the zipper. Therefore, the film 34 forms around the ends of the zipper profile when the sealing jaws 44 move inwards, without causing heat marks on the film.

The jaws 44 may be of any suitable design and form. They can for example be of the type described in our International patent application WO O1/28759 where each jaw has a plurality of spaced heat sealing wires, with a plurality of pressure switches associated with the wires and operable when pressure is imparted thereto to heat the wires. Alternatively, they can be flat-surface jaws heated by appropriate means. The welding of the film 34 to the zipper is effected by a suitable combination of the parameters of heat, pressure and time.

1. A method of sealing a reclosable fastener to a substrate which comprises presenting lengths of fastener to a continuous substrate, locating the lengths of fastener on the substrate by attaching them to the substrate so as to leave a body of the fastener free for movement, and passing the combination between a pair of sealing jaws which are dimensioned to be longer than the body of the fastener along the path of movement of the combination and which are displaceable relative to the combination to effect a sealing of the substrate to the fastener body when moved into contact therewith.

2. A method as claimed in claim 1, in which the length dimension of the sealing jaws is such as to form the substrate around the body of the fastener.

3. A method as claimed in claim 1 or 2, which includes locating the fastener between two substantially parallel webs of material, and initially attaching the lengths of fastener only to the inside of one of said webs of material.

4. A method as claimed in claim 3, which includes initially attaching the lengths of fastener by means of a single flange extending from one element of the fastener.

5. A method as claimed in any preceding claim, in which the lengths of fastener are presented to the substrate by a cross-web technique.

6. A method as claimed in any preceding claim, in which the body of the fastener comprises two engageable elements, each having an upstanding post at the margin of the fastener which is engageable with a heel of the other element at the opposing margin of said other element, with the respective posts and heels of the two elements angled at their respective contact surfaces.

7. Apparatus for sealing a -reclosable fastener to a substrate, comprising means for presenting lengths of fastener to a continuous substrate, means for attaching the lengths of fastener initially to the substrate so as to leave a body of the fastener free for movement, and a pair of sealing jaws between which the combination is arranged to pass, said jaws being dimensioned to be longer than the body of the fastener along the path of movement of the combination and being displaceable relative to the combination to effect sealing of the substrate to the fastener body when moved into contact therewith.

8. Apparatus as claimed in claim 7, in which the lengths of fastener are located between two substantially parallel webs of material, and are initially attached only to the inside of one of said webs of material.

9. Apparatus as claimed in claim 8, in which the lengths of fastener are initially attached by means of a single flange extending from one element of the fastener.

10. Apparatus as claimed in any of claims 7 to 9, in which the sealing jaws are preceded in the path of movement by another pair of jaws incorporating means to sever filled and sealed bags.
